(19) United States
(12) Patent Application Publication
(10) Pub. No.: US 2016/0168440 A1
(43) Pub. Date: Jun. 16, 2016

(54) SYNTHETIC POLYMERIZATION HEAT SINK AND SHIELD ENCLOSURE

(71) Applicant: Energy Bank Inc., Manitowoc, WI (US)

(72) Inventors: Neal R. Verfuerth, Manitowoc, IL (US); John M. Gagas, Milwaukee, WI (US)

(21) Appl. No.: 14/854,906

(22) Filed: Sep. 15, 2015

Related U.S. Application Data
(60) Provisional application No. 62/050,731, filed on Sep. 15, 2014.

(51) Int. Cl. C09K 5/14; C08K 3/34; C08K 3/04; C08K 3/22; C08K 3/36

(52) U.S. Cl. CPC C09K 5/14; C08K 3/22; C08K 3/2279; C08K 3/36; C08K 3/04; C08K 3/34; C08K 2003/2227

(57) ABSTRACT

The invention is directed to compositions and methods for using a synthetic polymerization composite to produce thermal dissipative products such as heat sinks, enclosures and supporting structures. The composition for forming a synthetic polymerization composite includes at least one polymerizable resin, at least one additive, and at least one curing agent.

### CROSS-REFERENCE TO RELATED APPLICATIONS

This application claims benefit of priority under 35 U.S.C. 119 to U.S. provisional patent application Ser. No. 62/050,731, filed Sep. 15, 2014, and entitled “SYNTHETIC POLYMERIZATION HEAT SINK AND SHIELD ENCLOSURE,” the contents of which are herein incorporated by reference in its entirety.

### FIELD OF THE INVENTION

This invention relates to methods and compositions directed to synthetic polymer materials having thermal dissipative properties for use as heat sinks, enclosures and supporting structures.

### BACKGROUND OF THE INVENTION

The primary function of a heat sink is to dissipate thermal energy from a heat generating source or object. Heat sinks are manufactured with methods using extruding, casting, machining, or stamping techniques. Extruded and casted heat sinks are used most often in higher powered and amplifier type cooling systems and LED lighting. Machined heat sinks are used in medium powered discrete component cooling, especially high value items like electronics and some in LED lighting. Stamped heat sinks are used in low power discrete component cooling.

Cast heat sinks do not have the limitations imposed by extrusions from a 2-D profile nor the backpressure inherent in the saw cut, non-aerodynamic front end of an extrusion. In forced air systems, the squared shape entrance of a saw cut edge creates a large pressure build up region, creating sharp edge and flow issues in the heat sink resulting in a higher air flow resistance. The loss reduction for this entrance shape can be approximated by: a K of 0.4 to 0.5 for a sharp edge inlet to a K of 0.20 to 0.05 for a slightly round to rounded entrance (radius=0.2*spacing gap). The perceived problem of resistance of the heat sink material being a major factor of natural or forced air cooling at this high power levels is only about 5% of the total resistance.

In a typical bonded heat sink, the bond material and joint to the overall thermal resistance of the full heat sink contributes about 3 to 20% loss for heat transfer. The primary contribution to the thermal resistance of bonded heat sinks is the convective contribution between the air and the surface. Other contributing factors are the base spreading conductive resistance of the heat sink and the metal conductive resistance of the conductor. Air gaps between the surfaces of the conductor and the heat sink composition reduces the effectiveness of heat transfer from the conductor surface to the heat sink composition.

### Heat Sink Materials

A variety of thermal dissipative materials serving as heat sinks are known in the art. Metals are the most common materials for heat sinks Aluminum, copper and oxides derived therefrom are common compositions for heat sinks because of their relatively high thermal conductivity and ease of manufacturing. Aluminum's low strength and melting temperature make it easy to extrude, stamp, or cast, and metal injection molding which can provide unique combinations of shape complexity, dimensional capability, and properties for high volume applications. Copper is often used for applications that require higher thermal conductivities than possible with aluminum. Copper is more difficult to extrude, cast, stamp or machine than aluminum, but copper is more commonly processed with powder metallurgy techniques or used as sheets. Copper oxides are more easily reduced than aluminum oxides, but reduction of copper oxides must occur while the pores are still interconnected. Water vapor can build up inside closed pores of copper oxide materials, thereby inhibiting densification and even leading to swelling if casted. Yet both aluminum- and copper-based compositions suffer from high thermal expansion, which provides challenges to mounting the heat sink to a silicon chip or ceramic substrate.

Some of these challenges can be overcome by using composite materials such as tungsten-copper, molybdenum-copper, and silicon carbide-aluminum, which combine high thermal conductivity with thermal expansion coefficients suitable for many packaging applications. Yet the cost such composites prevent their use in widespread applications.

Furthermore, secondary processing is required on metal heat sinks used in electrical equipment. Plating is required for industrial safety certification and government approval (for example, Underwriters Laboratory certification). Raw Aluminum will oxidize creating an insulating film that can be easily rubbed down onto the conductive surface. This leaves a danger of rubbing wires causing potential shorts. As a result of the need for additional processing, a heat sink for a typical 400-watt LED fixture can weigh over 130 lbs.

Thermally conductive composites for use as heat sink materials are known in the art. U.S. Pat. No. 4,107,135 to Duggins et al. discloses heat sink material comprising a filled polymeric article containing a dispersion of short, colored plastic nylon fibers.

U.S. Pat. No. 6,565,772 to Schneck describes a conductive resin comprising a molding resin, a cure accelerant and conductive particulates. The conductive resin is applied for hiding welding imperfections in automobile manufacturing.

U.S. Pat. No. 6,451,418 to Tobita describes a conductive resin material comprises polybenzasol fibers oriented in the thick direction of the substrate and its use as a substrate or a chip package.

U.S. Pat. No. 6,284,817 to Cross et al discloses a conductive resin-based material including aluminum oxide and zinc oxide particles. The material is used to bond a transistor to an aluminum heat sink.

U.S. Pat. No. 6,597,063 to Shimizu et al discloses a package for a semiconductor power device, wherein a high heat conductive resin is formed between the power device and the heat sink in one embodiment.

U.S. Patent Application 2003/0183379 to Krassowski et al. describes a composite heat sink comprising a graphite base and conductive plastic fins. The conductive plastic comprises graphite flakes in an injection molding resin base process.

U.S. Pat. No. 7,027,304 to Aisenbrey describes the combination of injection-molded, solid resins with conductive powders and fibers. This patent also describes the ability of plated conductors used in injection molding resins.

### Solid Surface Materials

Solid surface is a generic name given to a polymerized decorative surfacing material using a single matrix, which is typically found in kitchen and bath products. Solid surface is generally made with an acrylic or polyester resin as bonding agent, solids such as aluminum trihydrate and polymerized granules (chips). The polymerized granules possess fire retardant properties and enhance the appearance of the solid surface product. Paste pigments or dyes are also used for producing plain colors or in conjunction with chips for background colors. Formulations of the solid surface can vary widely depending on the desired effect, however, most solid surface producers tend to include 30% resin and 70% solids/fillers in their products.

The solid surface material category of particle filled polymer resins was created when DuPont developed CORIAN in the late-1960's. Since the introduction of CORIAN, similar filled polymeric materials have been introduced. Examples of these materials include GIBRALTAR and SSV by Wilsonart, FOUNTAINHEAD and SURELL by Formica Corporation, and AVONITE by Avonite Incorporated. The majority of these products were marketed initially as superior alternatives to laminate products for kitchen and bathroom applications. The particle filled polymer resins were appreciated subsequently for their solidity, hardness, durability, renewability, and fire resistance properties. The non-porous nature of the filled polymeric materials makes them easy to clean, resist dirt and grim infused into, and particularly resistant to bacteria, stains, and has great chemical resistance.

The aforementioned solid surface materials are composites and are referred to as artificial or synthetic marble owing to their appearance of natural stone such as marble or granite. Conventional artificial marble has certain limitations in providing various patterns. One typically makes artificial marble by curing a resin mixture, which includes resin syrup, inorganic filler, pigments, curing agents, and dispersing agents. Solid particles such as crushed artificial marble chips are often added to the resin mixture to improve the appearance of the final product. Typically, the artificial marble chips have a size of about 0.1-5 mm in size for this purpose. Both the acrylic and the polyester resins have good adhesive bonding abilities to each other.

In solid surface materials, the filled polymeric can include a liquid resin matrix, a suitable low profile additive, a catalyst, an inhibitor, a mold release agent, an extender, and may have a reinforcement filler. For example, U.S. Pat. No. 5,393,808 to Buonaura et al. discloses a filled polymeric material consisting of a resin-hydrogenated bis-phenol A, and a reinforcement comprised of glass fiber particles. Glass fibers introduced into a mixture cause the strength of the material to increase, but it also causes brittleness in the material.

U.S. Pat. Nos. 3,827,933 and 3,847,865 to Duggins et al. provide composite base materials comprising acrylic solid surfaces. U.S. 3,847,865 to Duggins et al., U.S. Pat. No. 3,396,067 to Schaefer, U.S. Pat. No. 3,663,493 to Miller, U.S. Patent Reissue. No. 27,093 to Slocum and U.S. Pat. No. 3,789,051 to Rees et al. describes the use of alumina trihydrate, mold release agents and viscosity reducers such as aliphatic acids in polymethylmethacrylate kitchen and bath products.

U.S. Pat. No. 5,244,941 to Bruckbauer et al. discloses a filled polymeric material comprises approximately 10 to 25 parts by weight of a non-volatile polyester backbone resin, approximately 10 to 25 parts by weight of an ethylenically unsaturated monomer, and approximately 50 to 80 parts by weight of a filler selected from the group consisting of alumina trihydrate, borax, hydrated magnesium calcium carbonate, and calcium sulfate dihydrate. The patent describes the addition of chips of a previously cured thermosetting resin composition.

U.S. Pat. No. 5,856,389 to Kostrzewski et al. discloses a typical material used for kitchen and bath is a filled polymeric article consisting of 16 to 28 percent, preferably 19 to 25 percent, by weight of a clear or transparent thermoplastic acrylic polymer, preferably polymethyl methacrylate; 16 to 28 percent, preferably 19 to 25 percent, by weight of a clear or transparent impact enhancer thermoplastic polymer, preferably styrene-acrylonitrile copolymer; 5 to 20 percent, preferably 8 to 15 percent, by weight of a clear or transparent thermoplastic polymer, preferably styrene-maleic anhydride copolymer with a maleic anhydride content of no more than 10 percent; and 20 to 65 percent, preferably 35 to 60 percent, by weight of an inorganic filler having an index of refraction similar to that of the polymers, such as barium sulfate, wollastonite, basic aluminum oxalate and kaolin.

U.S. Pat. No. 7,544,317 to Kraker describes the method and article of preparing a solid surface material having a simulated burled wood effect. This process uses isophthalic polyester resin, alumina trihydrate, iron oxide pigments and pearlescent mica pigments and using a catalyzing agent like MEKP. This process is for making slabs having a wood-like pattern. The described resins upon curing tend to be fairly rigid, are more brittle, experience lower shrinkage and have a higher heat distortion temperature than orthophthalic types of polyester resins.

U.S. Pat. No. 8,211,536 to Rha et al. describes a composite solid surface product containing fibers and polymeric powder particles having a specific size for kitchen and bath products as well as walls coverings for interior and exterior.

U.S. Pat. No. 6,197,180 to Kelly describes the covering of surfaces with microstructures. This patent deals with the electroplating processes in the coating of surfaces to increase the properties and performance.

U.S. Pat. No. 6,194,051 to Gagas et al. describes an outdoor cross-linked resin with fibers to enhance the rigidity of the structure and load bearing.

### BRIEF SUMMARY OF THE INVENTION

In one aspect, a composition for forming a synthetic polymerization composite is provided. The composition includes at least one polymerizable resin, at least one additive, and at least one curing agent.

In a second aspect, a thermal dissipative product comprising a cured synthetic polymerization composite is provided. The cured synthetic polymerization composite includes at least one polymerized resin and at least one additive.

In a third aspect, a method of making a thermal dissipative product comprising a cured synthetic polymerization composite is provided. The cured synthetic polymerization composite includes at least one polymerized resin and at least one additive. The method includes several steps. The first step includes providing a composition for forming a synthetic polymerization composite, wherein the composition includes at least one polymerizable resin, at least one additive, and at least one curing agent. The second step includes disposing the composition into a mold casting. The third step includes curing the composition.

### DETAILED DESCRIPTION OF THE INVENTION

Certain terms are first defined. Additional terms are defined throughout the specification.

Terms used herein are intended as “open” terms. For example, the term “including” should be interpreted as “including but not limited to,” the term “having” should be interpreted as “having at least,” the term “includes” should be interpreted as “includes but is not limited to,” etc. As used herein, open terms, such as “comprise,” “include” and “have” are used interchangeably throughout the specification.

Furthermore, in those instances where a convention analogous to “at least one of A,B and C, etc.” is used, in general such a construction is intended in the sense of one having ordinary skill in the art would understand the convention (for example, “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “from,” “to,” “up to,” “at least,” “greater than,” “less than,” and the like, include the number recited and refer to ranges that can subsequently be broken down into sub-ranges as the context warrants.

A range includes each individual member. Thus, for example, a group having 1-3 members refers to groups having 1, 2, or 3 members. Similarly, a group having 6 members refers to groups having 1, 2, 3, 4, 5 or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use and aspect of a described embodiment or feature contained in the same, or a definitive decision to use a specific skill regarding a described embodiment or feature contained in the same. In this latter context, the modal verb “may” has the same meaning and connotation as the auxiliary verb “can.”

As used herein, the articles “a,” “an” and “the” refer to one or to more than one (for example, to at least one) of the grammatical object of the article. Accordingly, the singular forms “a,” “an,” and “the” include plural referents unless the context clearly dictates otherwise.

As used herein, “or” is used herein to mean, and is used interchangeably with, the term “and/or”, unless context clearly indicates otherwise. The use of the term “and/or” in some places herein does not mean that uses of the term “or” are not interchangeable with the term “and/or” unless the context clearly indicates otherwise.

“About” and “approximately” shall generally mean an acceptable degree of error for the quantity measured given the nature or precision of the measurements. Exemplary degrees of error are within 25 percent (%), typically, within 10%, and more typically, within 5% of a given value or range of values.

The term “composite” refers to a solid composition that includes two or more materials or ingredients.

The terms “synthetic polymerization,” “synthetic polymerization composite,” “polymerized solid surface” and “cured composite” are used interchangeably throughout the specification and refers a polymer-based material capable of being cast into a molded shape having thermal dissipative properties with respect to an object or source in contact with the polymer-based material. An example of a “synthetic polymerization,” “synthetic polymerization composite,” “polymerized solid surface” or “cured composite” includes at least one polymerizable resin and at least one additive.

Compositions that include liquid components are specified in percentages in terms of weight to volume (wt/vol or w/v), unless the context dictates otherwise (for example, molar concentration).

Headings, for example, (a), (b), (i) etc., are presented merely for ease of reading the specification and claims. The use of headings in the specification or claims does not require the steps or elements be performed in alphabetical or numerical order or the order in that they are presented.

The present inventors have identified synthetic polymerization composites having efficient thermal dissipative properties, lightweight designs, and aesthetically customizable configurations for replacing metal heat sink materials in a variety of electronic and lighting applications. The disclosed heat sinks, enclosures and supporting structures made from the synthetic polymerization composites provide more heat energy movement and transfer, a smaller footprint, and greater energy savings than a conventional metal materials.

### Compositions

One aspect of the invention is a composition for forming a synthetic polymerization composite comprising;
(a) at least one polymerizable resin;
(b) at least one additive; and
(c) at least one curing agent.

In some aspects, the at least one polymerizable resin is selected from an isophthalic resin or an orthophthalic resin. Isophthalic resins composed of polyester polymer modified with an acrylic monomer are generally preferred polymerizable resins. Exemplary polyester polymers include polystyrene, high-density polyethylene (HDPE) and polyethylene terephthalate glycol (PETG). Exemplary acrylic monomers include methyl methacrylate, 2-(dimethylamino)ethyl methacrylate, 2-(dimethylamino)ethyl acrylate, 2-hydroxyethyl methacrylate, 1,6-hexanediol diacrylate, 1,6-hexanediol dimethacrylate and 2-methoxyethyl acrylate, among others, including combinations thereof.

In other aspects, the at least one polymerizable resin includes a thermoplastic resin. Such resins include colorization materials, such as pigments, among others. Such resins can be combined in mixtures with non-thermoplastic resins to mitigate their thermally induced softening properties.

In other aspects, the at least one polymerizable resin includes an epoxy resin.

In preferred aspects, the at least one polymerizable resin includes a thermosetting resin such as polyester and epoxy-based resins. Thermosetting materials, or ‘thermosets’, are formed from a chemical reaction in situ, where the resin and hardener or resin and catalyst are mixed and then undergo a non-reversible chemical reaction to form a hard, infusible product. Thermosetting resins such as polyester and epoxy cure by mechanisms that do not produce any volatile by products and thus are much easier to process. Once cured, thermosets will not become liquid again if heated, although their mechanical properties will change significantly above a certain temperature (that is, the glass transition temperature (Tg)).

The at least one polymerizable resin can comprise from about 10% wt to about 45% wt of the composition. The at least one polymerizable resin comprises preferably about 30% wt of the composition.

The at least one additive is selected from the group of inorganic fillers, such as heat conductive materials and flame retardant materials, UV stabilizers, colorization materials, fiber materials, and polymerization modifiers. Examples of heat conductive materials include metals such as aluminum, copper and byproducts made of the same. Examples of flame retardant materials include aluminum trihydrate, antimony trioxide, antimony pentoxide, carbon fiber, carbon black and aramid fiber, among others. Examples of UV stabilizers include benzylidene malonates, oxalanilides, hydroxybenzophenones and halogenated benzotriazoles, among others. Examples of colorization materials include chemical compounds such as iron oxides, zinc sulfide, zinc oxide and titanium dioxide, pigments and plastic particulates, among others. Where colorization materials are particulate materials, exemplary particles having a mean diameter ranging from 0.01 mm to about 100 mm are preferred. Examples of fiber materials include aramid, carbon, graphite, cotton, copper and wire strands, among others. Where fiber materials are employed, exemplary materials having a width ranging from about 0.001 mm to about 100 mm. Examples of polymerization modifiers include fumed silica, maleic anhydride, fumaric acid, phthalic anhydride, terephthalic acid, isophthalic acid, adipic acid, propylene glycol (1.2-propanediol) and neopentyl glycol, among others. Exemplary amounts of each of the additives typically ranges from about 1 part per hundred parts polymerizable resin (for example, additives such as colorization materials, UV stabilizers, among others) to about 120 parts per hundred parts polymerizable resin (for example, aluminum trihydrate).

The at least one additive can comprise from about 55% wt to about 90% wt of the composition. The at least one additive comprises preferably about 70% wt of the composition.

Table I lists some exemplary additives for the composition for forming a synthetic polymerization composite.

TABLE I
Exemplary additives

| Additive | Amount¹ | Effect/Purpose |
|---|---|---|
| Fumed silica | 1-2 | Thixotropy (viscosity control) |
| Antimony trioxide | 1-5 | Fire retardant synergist |
| Antimony pentoxide | 3-5 | Fire retardant synergist |
| Aluminum trihydrate | 50-120 | Fire retardant; low smoke formulation |
| Carbon black/graphite | 1-30 | Electrical conductivity |
| Silica carbide | 1-30 | Abrasion resistance |
| Pigments/UV stabilizer | 1-2 | Cosmetics/UV protection |

¹Parts per hundred parts resin

The at least one curing agent is used for providing reproducible polymerization of the synthetic polymerization composite. Examples of an at least one curing agent include methylethylketone peroxide (MEKP), 2,4 pentanedione peroxide (2,4-PDPO), benzoyl peroxide (BPO) and cumene hydroperoxide (CHP), among others, including blends of two or more curing agents.

In some aspects, the composition for forming a synthetic polymerization composite includes preferably two or more additives, such as a colorization material (for example, a pigment) and an inorganic filler (for example, aluminum trihydrate). A preferred at least one additive includes an inorganic filler such as aluminum trihydrate.

### Methods

Another aspect of the invention also provides a method of producing a composite solid surface product. The method comprises: conveying solid/filler particles along a passage; adding a solid surface forming slurry to the solid/filler particles that are being conveyed when the solid particles and passing a location in the passage; blending the solid surface forming slurry and the solid/filler particles; thickening the solid surface forming slurry while blending, thereby forming a flowable synthetic polymerization composite comprising the solid particles dispersed therein homogeneously; flowing the flowable synthetic polymerization composite into a cast and curing synthetic polymerization composite to form a cured composite structure. Optimal curing temperatures and times to achieve the desired appearance and form factor are well within the purview of one of ordinary skill in the art. Additional steps include releasing the cured synthetic polymerization composite from the casting and finishing the cured composite structure.

Processing can be done using a vacuum reaction kettle and mixed with a high-speed dispersion blade or in an automated mixing machine. A vacuum mixer is designed to create the matrix material by evacuating air from the matrix during the blending process. A pot washing system, such as the ThermaClean Marble wash pot washing system by Gruber, is used to clean the kettle. In the automated high volume systems all components are supplied air fee to a static mix head. Cleaning of this equipment is the removal of the mix tub and replacing it. Most high-volume solid surfaces products are cast in a continuous process that uses conveyors to draw out the material. Enclosures and other shapes are cast by having the resin poured into molds. It is important that no air bubbles be entrapped in the mix, as this would result in voids and weakening of the material and loses in thermal transfer. This is accomplished either by adjusting the viscosity of the mix, by vibration or by vacuum or a combination of these.

The method for making a molded batch product comprises the following steps. The first step is providing at least one mold charge unit having a molding composition comprising a liquid polymerizable composite resin including at least one volatile monomer reactive material. The curing/mixing process can be added at the ends of the casting with an injection of air control agents, which blow out any air, to ensure that the finished material is void-free and non-porous. Commercial air control agents used in polyester and acrylic surface production may contain an aromatic naptha. BYK, for example, supplies air release additives, such as BYK-A 555 and BYK-A 560, can be added to the polyester and acrylate-modified polyester matrix. The liquid polymerizable composite resin can include stabilizers, accelerators, anti-gelling agents as part of the resin, but could be added at this time if not. The second step is adding to the liquid polymerizable composite resin at least one additive (for example, the fillers, aluminum trihydrate, metal fillers, strands, fiber, or any other property enhancing components, if making a style design the addition of colorant, and particle chips, UV stabilizer and any other ingredients). The third step is mixing under vacuum until the at least one additive is mixed, dispersed, and distributed within the liquid polymerizable composite resin. The fourth step is adding the at least one curing agent to the resultant mixture under vacuum to form the final composition for forming a synthetic polymerization composite. The fifth step is pouring composition for forming a synthetic polymerization composite into mold casting. The sixth step is vibrating the mold casting as needed to aid in pouring into mold and for air release. The final step is performing post-curing procedures as needed to ensure the solid surface is fully cured.

### Applications

The composition for forming a synthetic polymerization composite is amenable for casting any heat sink, enclosure or supporting structure. Typical applications include electronic circuits such as computer motherboards and amplification circuit boards; high output thermal energy generating sources, such power generators, motors, LEDs, plasma displays, and halogen lamps; lighting fixtures and lamp ballasts, such as stage lighting, traffic control signals, as well as lighting and displays for parks, recreational areas and sports arenas.

The synthetic polymerization composites disclosed herein have flowable properties in their uncured state, thereby allowing for manufacture of heat sink, enclosure or supporting structure having any shape, texture and appearance. Some aspects of synthetic polymerization composites upon curing include solid surfaces having a homogenous matrix that is machinable, yet hard, substantially non-porous, unaffected by changes in humidity, resistant to staining, chemicals, mold, mildew and bacteria, fireproof, flame-resistant and flame retardant. Owing to the durability of the solid surface, heat sink, enclosure or structure that include the solid surface can have long lifespan in the field.

### Incorporation by Reference

All publications, patents, and patent applications mentioned herein are hereby incorporated by reference in their entirety as if each individual publication, patent or patent application was specifically and individually indicated to be incorporated by reference. In case of conflict, the present application, including any definitions herein, will control.

The terminology used herein is for the purpose of describing particular embodiments only, and is not intended to be limiting. With respect to the use of substantially, any plural and/or singular terms herein, those having skill in the art can translate from the plural as is appropriate to the context and/or application. The various singular/plural permutations may be expressly set forth herein for the sake of clarity.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments or examples disclosed, but that the present invention will include all embodiments falling within the scope of the appended claims.

1. A composition for forming a synthetic polymerization composite comprising:
(a) at least one polymerizable resin;
(b) at least one additive; and
(c) at least one curing agent.

2. The composition of claim 1, wherein the at least one polymerizable resin is selected from the group consisting of isophthalic resin, orthophthalic resin, thermoplastic resin and epoxy resin, or combinations thereof.

3. The composition of claim 1, wherein the at least one polymerizable resin is modified with an acrylic monomer.

4. The composition of claim 3, wherein the acrylic monomer is selected from the group consisting of methyl methacrylate, 2-(dimethylamino)ethyl methacrylate, 2-(dimethylamino)ethyl acrylate, 2-hydroxyethyl methacrylate, 1,6-hexanediol diacrylate, 1,6-hexanediol dimethacrylate and 2-methoxyethyl acrylate, or combinations thereof.

5. The composition of claim 3, wherein the at least one polymerizable resin comprises an isophthalic resin.

6. The composition of claim 5, wherein the isophthalic resin comprises polystyrene.

7. The composition of claim 6, wherein the acrylic monomer is selected from the group consisting of methyl methacrylate, 2-(dimethylamino)ethyl methacrylate, 2-(dimethylamino)ethyl acrylate, 2-hydroxyethyl methacrylate, 1,6-hexanediol diacrylate, 1,6-hexanediol dimethacrylate and 2-methoxyethyl acrylate, or combinations thereof.

8. The composition of claim 1, wherein the at least one additive is selected from the group consisting of inorganic fillers, UV stabilizers, colorization materials, fiber materials, and polymerization modifiers, or combinations thereof.

9. The composition of claim 1, wherein the at least one additive comprises an inorganic filler selected from heat conductive materials and flame retardant materials.

10. The composition of claim 1, wherein the at least one additive comprises an inorganic filler selected from a heat conductive material comprising a metal.

11. The composition of claim 10, wherein the metal comprises aluminum, aluminum oxide, copper and copper oxide, or mixtures thereof.

12. The composition of claim 1, wherein the at least one additive comprises a flame retardant material selected from aluminum trihydrate, antimony trioxide, antimony pentoxide, carbon fiber, carbon black and aramid fiber, or combinations thereof.

13. The composition of claim 1, wherein the at least one additive comprises a flame retardant comprising aluminum trihydrate.

14. The composition of claim 1, wherein the at least one additive comprises a UV stabilizer.

15. The composition of claim 14, wherein the UV stabilizer is selected from the group consisting of benzylidene malonates, oxalanilides, hydroxybenzophenones and halogenated benzotriazoles, or combinations thereof.

16. The composition of claim 1, wherein the at least one additive comprises a colorization material.

17. The composition of claim 16, wherein the colorization material is selected from the group consisting of a metal compound, a pigment, a plastic particulate, or combinations thereof.

18. The composition of claim 16, wherein the colorization material comprises a metal compound.

19. The composition of claim 18, wherein the metal compound is selected from the group consisting of iron oxide, zinc sulfide, zinc oxide, titanium dioxide and combinations thereof.

20. The composition of claim 1, wherein the at least one additive comprises a fiber material.

21-51. (canceled)
